(19) United States
(12) Patent Application Publication
(10) Pub. No.: US 2013/0285904 A1
(43) Pub. Date: Oct. 31, 2013

(54) COMPUTER VISION BASED CONTROL OF AN ICON ON A DISPLAY

(71) Applicant: Pointgrab Ltd., Hod Hasharon (IL)

(72) Inventors: Amir KAPLAN, Hod-HaSharon (IL); Ovadya Menadeva, Modiin (IL); Eran Eilat, Givatayim (IL); Tomer Peled, Nes Tziona (IL); Haim Perski, Hod-HaSharon (IL)

(21) Appl. No.: 13/932,137

(22) Filed: Jul. 1, 2013

Related U.S. Application Data
(63) Continuation of application No. PCT/IL2013/050146, filed on Feb. 20, 2013.
(60) Provisional application No. 61/601,571, filed on Feb. 22, 2012.

(51) Int. Cl. G06F 3/01

(52) U.S. Cl. CPC G06F 3/017
USPC 345/157; 345/156

(57) ABSTRACT

A method for computer vision based hand gesture device control, is provided. The method includes receiving a sequence of images of a field of view; applying a shape recognition algorithm on the sequence of images to detect a shape of a first posture of a hand; and generating a command to initiate device control based on the detection of the shape of the first posture of the hand.

### CROSS-REFERENCE TO RELATED APPLICATIONS

This application is a continuation of PCT International Application No. PCT/IL2013/050146, International Filing Date Feb. 20, 2013, claiming priority of U.S. Provisional Application No. 61/601,571, filed on Feb. 22, 2012, both of which are incorporated by reference in their entirety.

### FIELD OF THE INVENTION

The present invention relates to the field of computer vision based control of electronic devices. Specifically, the invention relates to computer vision based control of an icon, such as a cursor, on a display of the electronic device.

### BACKGROUND OF THE INVENTION

The need for more convenient, intuitive and portable input devices increases as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines naturally without any mechanical appliances. The development of alternative computer interfaces (forgoing the traditional keyboard and mouse), video games and remote controlling are only some of the fields that may implement human gesturing techniques.

Controlling a device using existing systems which include a camera, as described above, typically requires recognizing an initialization signal from a user (usually a predetermined movement of the user's hand) to initiate a control mode. Hand gestures are then identified. Recognition of a hand gesture usually requires identification of an object as a hand and tracking the identified hand to detect a posture or gesture that is being performed. Tracking the identified hand may be used to move an icon or symbol on a display according to the movement of the tracked hand.

While operating such a system the user must keep his hand at a set position in relation to the camera of the system because changes in the positioning of the hand relative to the original hand position might cause changes in the rotation or pitch of the hand thereby interrupting the tracking of the hand.

In general, controlling a device based on computer vision recognition of user hand gestures may be tiring for the user, requiring the user to remember and to perform many different gestures.

These limitations of existing systems may cause less than smooth operation of the system as well as cause discomfort for the user.

### SUMMARY OF THE INVENTION

A method according to embodiments of the invention provides ease of use and smooth operation of a system for controlling a device, for example, for controlling movement of an icon on a display of a device.

Embodiments of the invention naturally and unobtrusively causes a user to limit the range of his hand movements thereby avoiding changes to the positioning of the hand and keeping the user from leaving of the camera field of view.

According to one embodiment, initiation of a control mode of a device does not require any specific movement of a user's hand. A user may indicate his desire to initiate hand control of the device by simply placing his hand within the field of view (FOV) of the camera.

The term “initiation” or “initiating device control” typically means activating a device after an inactive period. Activation may include causing changes in a device's display (such as a change of icons or GUI) and/or enabling user commands (such as moving a displayed object based on movement of the user's hand, opening an application, etc.)

Embodiments of the invention may also enable smooth operation in a multi-device environment.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a method for initiating a system according to one embodiment of the invention;

FIG. 2 schematically illustrates a method for initiating a system according to another embodiment of the invention;

FIG. 3 schematically illustrates a method for initiating a multi-device system according to embodiments of the invention;

FIGS. 4A, 4B, 4C and 4D schematically illustrate a method for controlling movement of an icon on a display, based on computer vision, according to embodiments of the invention;

FIGS. 5A, 5B and 5C schematically illustrate a method for controlling movement of an icon on a display, based on computer vision, according to additional embodiments of the invention;

FIG. 6 schematically illustrates a method for determining the distance of the hand from the reference point, according to an embodiment of the invention;

FIG. 7 schematically illustrates a method for controlling a device, based on computer vision, according to an embodiment of the invention;

FIG. 8 schematically illustrates a method for controlling a device, based on computer vision, according to another embodiment of the invention; and

FIG. 9 schematically illustrates a method for controlling displayed content according to an embodiment of the invention.

### DETAILED DESCRIPTION OF THE INVENTION

Embodiments of the present invention provide hand gesture based control of a device which is less burdensome for the user than currently existing methods of control.

For example, embodiments of the invention use asymmetric acceleration of an icon on a display, so as to help direct movement of the user's hand such that the hand stays in proximity to a certain reference point. The reference point can be, for example, the initial position of the hand or the center of a field of view of a camera which is used to obtain images of the user's hand.

Typically, methods according to embodiments of the invention are carried out on a system which includes an image sensor for obtaining a sequence of images of a field of view (FOV), which may include an object. The image sensor is typically associated with a processor and a storage device for storing image data. The storage device may be integrated within the image sensor or may be external to the image sensor. According to some embodiments image data may be stored in a processor, for example in a cache memory.

The processor is in communication with a controller which is in communication with a device. Image data of the field of view is sent to the processor for analysis. A user command is generated by the processor, based on the image analysis, and is sent to the controller for controlling the device. Alternatively, a user command may be generated by the controller based on data from the processor.

The device may be any electronic device that can accept user commands from the controller, e.g., TV, DVD player, PC, mobile phone or tablet, camera, STB (Set Top Box), streamer, etc. According to one embodiment, the device is an electronic device available with an integrated standard 2D camera. According to other embodiments a camera is an external accessory to the device. According to some embodiments more than one 2D camera are provided to enable obtaining 3D information. According to some embodiments the system includes a 3D camera.

Processors being used by the system may be integrated within the image sensor and/or within the device itself.

The communication between the image sensor and the processor and/or between the processor and the controller and/or the device may be through a wired or wireless link, such as through IR communication, radio transmission, Bluetooth technology and/or other suitable communication routes.

According to one embodiment the image sensor is a forward facing camera. The image sensor may be a standard 2D camera such as a webcam or other standard video capture device, typically installed on PCs or other electronic devices.

The processor can apply computer vision algorithms, such as motion detection and shape recognition algorithms to identify and further track an object, typically, the user's hand. Machine learning techniques may also be used in identification of an object as a hand.

A system according to embodiments of the invention is initiated once a user's hand is identified. Thus, a user needs to bring his hand into the field of view of the camera of the system in order to turn on computer vision based hand gesture device control.

According to one embodiment, identification of an object as a hand, based on recognition of a shape of a hand in a specific posture, is used as an initiation signal for the system. According to some embodiments motion parameters of the hand (for example, the direction of movement of the hand, movement vs. non movement of the hand, etc.) may also be taken into consideration while identifying an object as a hand.

Once the object is identified as a hand it may be tracked by the system. The controller may generate a user command based on identification of a movement of the user's hand in a specific pattern or direction based on the tracking of the hand. A specific pattern of movement may be for example, a repetitive movement of the hand (e.g., wave like movement). Alternatively, other movement patterns (e.g., movement vs. stop, movement to and away from the camera) or hand shapes (e.g., specific postures of a hand) may be used to control the device.

The system typically includes an electronic display. According to embodiments of the invention, mouse emulation and/or control of a cursor on a display, are based on computer visual identification and tracking of a user's hand, for example, as detailed above.

Movement of a user's hand may be used to move a cursor on a display. In one embodiment movement of the cursor is linear with the hand movement so that dX=k*dX′, wherein dX is the cursor movement, k is a constant (e.g., a natural number) factor and X′ is the hand movement. In another embodiment a system may include acceleration software which detects movement of a user's hand and which accelerates cursor movement in accordance with the hand movement, so that, for example, dX=k*dX′*dX′. In this embodiment very small and accurate movement of the cursor is enabled when the hand moves slowly, while allowing big and fast movements of the cursor when the hand moves quickly.

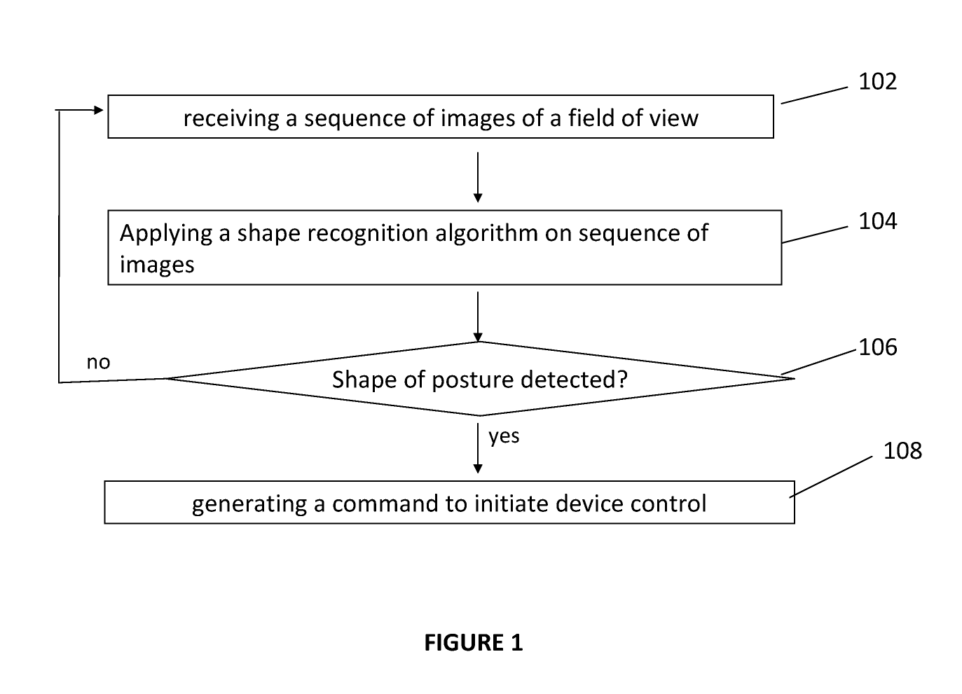

FIG. 1 schematically illustrates a method for initiating a system according to one embodiment of the invention. The method includes receiving a sequence of images of a field of view (102); applying a shape recognition algorithm on the sequence of images (104) to detect a shape of a first posture of a hand. If a shape of a first posture is detected (106) then a command to initiate device control is initiated (108). If the shape of the first posture is not detected additional images are checked.

The first posture may be a hand with all fingers extended. Other postures are possible.

According to some embodiments, once the shape of the first posture is identified, an indication to the user is generated. The indication may be a graphical indication appearing on a display or any other indication to a user, such as a sound, flashing light or a change of display parameters, such as brightness of the display.

In one embodiment the command to initiate device control includes a command to move an icon on a display of the device according to movement of the hand. According to one embodiment the icon is moved according to movement of the hand only while the hand is in the first posture. Thus, the graphical indication may be a cursor (for example) which moves on the display in accordance with movement of a hand. According to one embodiment the cursor is moved on the display in accordance with movement of the hand which is in the first posture.

According to some embodiments movement of a hand (optionally, a hand which is in the first posture) is tracked and a command to initiate the device is generated only if the movement of the hand is in a single, optionally pre-determined, direction. Movement in a single direction may be movement from one end of the field of view to an opposing end, for example, from a lower to higher point within the field of view.

A user's hand is initially held up in the field of view of a camera in a first posture, for example, an open hand, fingers extended and palm facing the camera. According to one embodiment, once a shape of a hand in a first posture has been detected, the user is required to change the posture of his hand from the first posture to a second posture, a “control posture”. In this embodiment a command to initiate device control is generated based on the detection of a shape of a hand in the first posture and on the detection of the control posture. The use of a “confirming stage” in which a second posture must be detected after a first posture was detected helps to avoid false initiation which can occur due to incorrect detection of a hand shape, the user unintentionally bringing his hand into the field of view of the camera, etc.

According to one embodiment a control posture is a posture in which the tips of all fingers of the hand brought together such that the tips touch or almost touch each other, as if the hand is holding a bulb or valve. Another posture may include a “pinching” posture in which two fingers (typically the thumb and another finger) are brought together as if pinching something. Other postures may be used.

According to one embodiment the method includes detecting a shape of a second posture of a hand and generating a command to initiate device control based on the detection of the shape of a first posture and detection of the shape of the second posture.

According to some embodiments the system may detect a change of posture from a first posture to a second posture and a command to initiate device control is generated based on the detected change.

According to some embodiments the method includes detecting movement of an object within the sequence of images; detecting a pause in the movement to define a paused object; and applying the shape recognition algorithm on the paused object to detect a shape of a first posture of a hand.

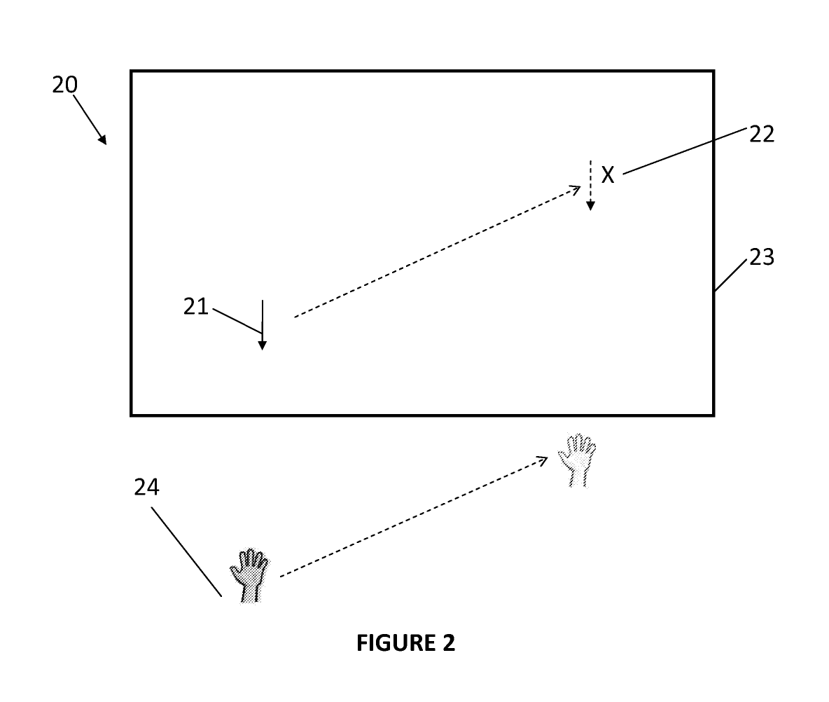

According to one embodiment, which is schematically illustrated in FIG. 2, a method for initiating a system includes causing a second graphical indication (22) to be presented on a display (23) of a device (20), at a location other than the location of the first graphical indication (21). The method includes causing the first graphical indication (21) to move on the display according to movement of the hand (24), which may be in the first posture. According to some embodiments, only when the first graphical indication (21) is brought to the location of the second graphical indication (22) (or in close proximity to it), a command to initiate device control is executed.

The location of the second graphical indication (22) may be generated randomly by the device (20). The location of the second graphical indication (22) may be specific to a type of a device, for example, in TVs graphical indication (22) may be located at a specific corner of the display but in PCs the graphical indication (22) may be located in the center of the display.

This embodiment may be useful, inter alia, in a multi device environment where several devices are controlled through hand gesturing. Each device of the several devices may have a different predetermined (or randomly generated) location on its display which is used to initiate the device, thereby ensuring specificity of the device to be operated.

According to one embodiment a multi-device system is operated by receiving a sequence of images of a field of view; applying a shape recognition algorithm on the sequence of images to detect a shape of a first posture of a hand; detecting an action of the hand in the first posture; correlating the action of the hand to a device from the plurality of devices; and generating a command to initiate the device control based on the detection of the action, wherein a first device of the plurality of devices correlates to a first action and a second device of the plurality of devices correlates to a second action. The actions may include the hand performing a posture or a gesture. According to one embodiment the action includes moving the hand in a pre-defined direction

According to some embodiments an indication of a required action to a user is generated or displayed, such as a menu or other assistance to the user.

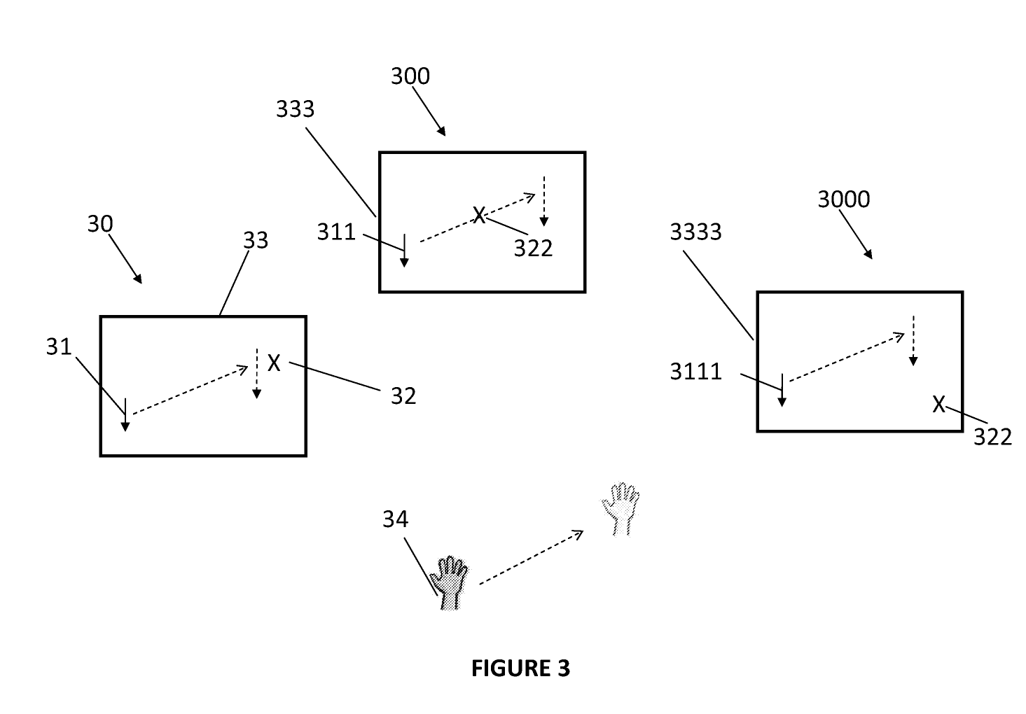

According to one embodiment, which is schematically illustrated in FIG. 3, the method includes causing a first icon (31, 311 and 3111) to be displayed on displays (33, 333, and 3333) of devices (30, 300 and 3000), the first icon being movable according to movement of the hand 34. Some or all of the devices (30, 300 and 3000) have a second icon (32, 322 and 3222) displayed at a location other than the location of the first icon (31, 311 and 3111). The location of the second icon (32, 322 and 3222) on the displays (33, 333, and 3333) may be different for each device of the plurality of devices or for each type of device (e.g., TVs and PCs). The user is required to move the first icon (31, 311 and 3111) by movement of his hand 34 to the location of the second icon (32, 322 and 3222) on the specific device (30, 300 and 3000) which he desires to initiate. A command to initiate device control will be generated only in the device in which the first icon is moved to or in close proximity to the location of the second icon (in this example, in device 30).

In one embodiment the user is required to change the posture of his hand to a control posture after an indication (e.g., a graphical indication, such as an icon or symbol on a display) is generated.

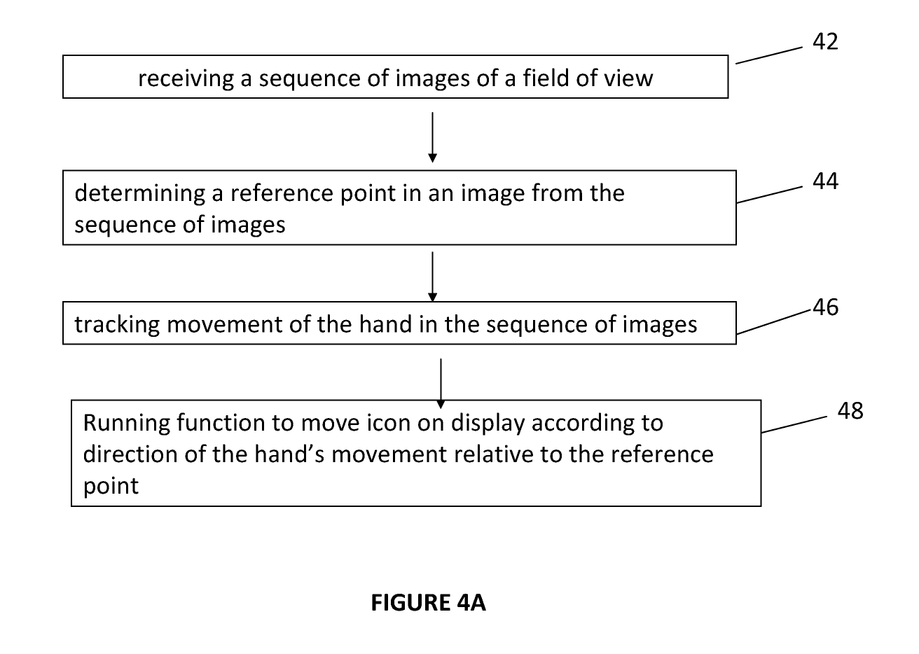

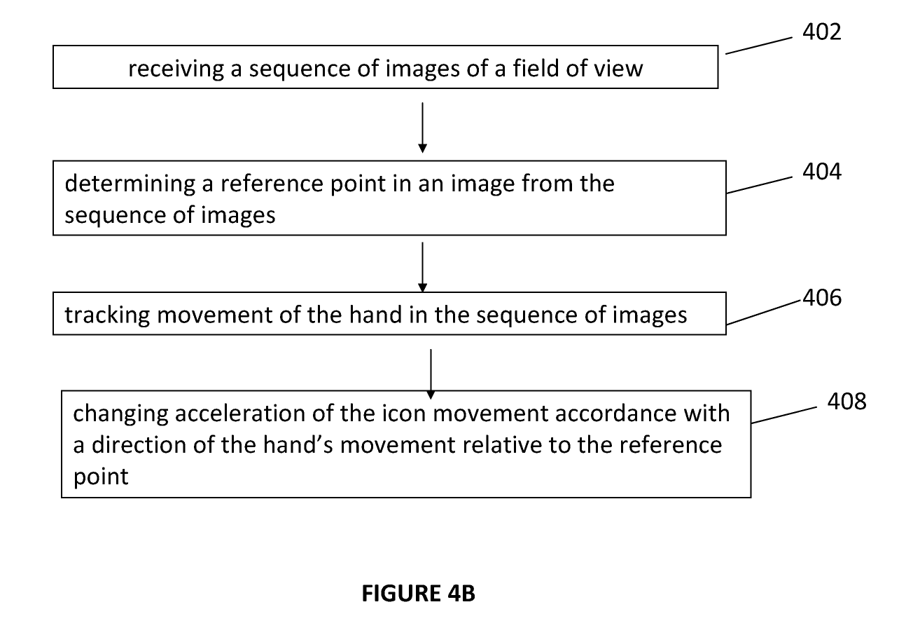

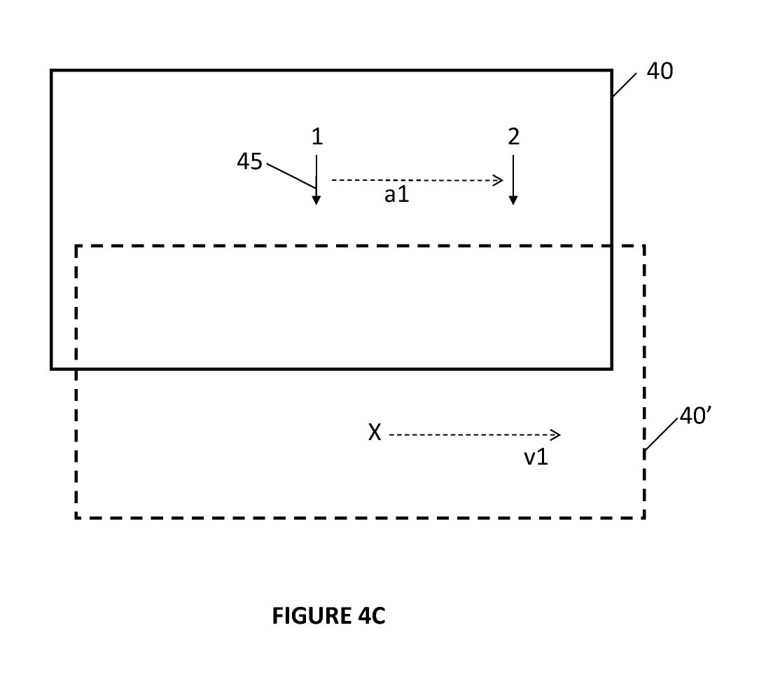

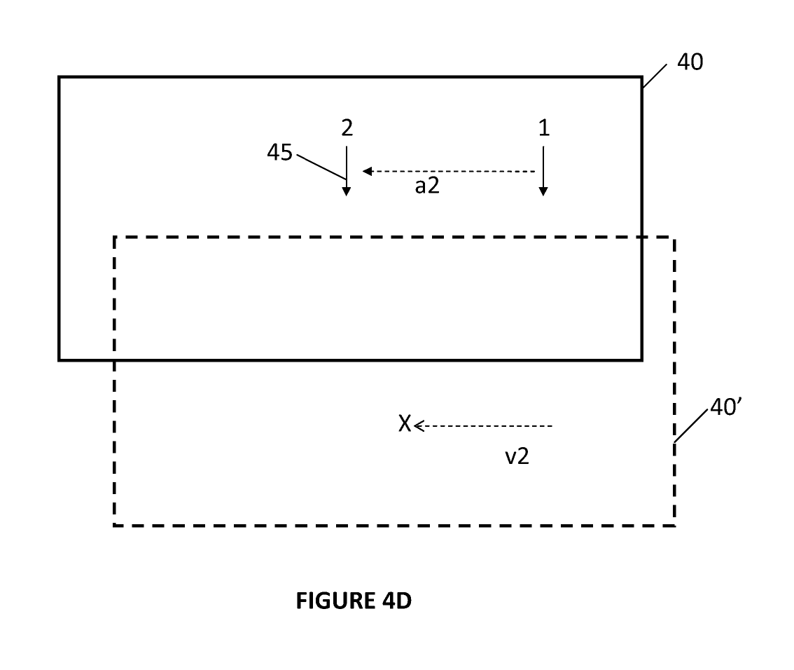

A method for controlling movement of an icon, such as a cursor, on a display, based on computer vision, according to one embodiment of the invention is schematically illustrated in FIGS. 4A-4D.

In one embodiment, illustrated in FIG. 4A, a method for controlling movement of the cursor on the display may include the steps of receiving a sequence of images of a field of view (42), the images including at least one hand of a user; determining a reference point in an image from the sequence of images (44); tracking movement of the hand in the sequence of images (46); and running a function which moves the icon on the display in accordance with a direction of the hand's movement relative to the reference point (48). According to one embodiment the function is a linear function, for example, the cursor movement may be the result of a determined constant factor and the user's hand movement. According to another embodiment the function is non-linear, for example, cursor movement on a display may be accelerated in accordance with the user's hand movement.

According to some embodiments the function causes the icon to move faster when the hand is moving away from the reference point than when the hand is moving towards the reference point.

According to one embodiment, which is schematically illustrated in FIG. 4B, acceleration of the icon is changed in accordance with the direction of the hand's movement relative to the reference point. According to one embodiment the acceleration of the icon is increased when the hand is moving away from the reference point and the acceleration of the icon is decreased when the hand is moving towards the reference point.

According to one embodiment the method includes the steps of receiving a sequence of images of a field of view (402), the images including at least one hand of a user; determining a reference point in an image from the sequence of images (404); tracking movement of the hand in the sequence of images (406); and changing acceleration of the icon movement on a display in accordance with a direction of the hand's movement relative to the reference point (408).

Thus, when a user starts using a system according to embodiments of the invention, by placing his hand within a field of view of a camera, images which include the user's hand are obtained. A reference point X within an image frame 40′ is determined by the system. According to one embodiment the reference point X may be a point in the center of the field of view of the camera (usually, in the center of image frame 40′). According to another embodiment the reference point X may be an initial position of the user's hand (e.g., the location of the hand within the image frame 40′ at a specific time during onset of operation by the user).

The user then moves his hand, for example, in the direction depicted by vector v1. A cursor 45 (or other icon or symbol) which was initially located at location 1 on display 40 is moved according to the user's hand movement to location 2 on the display 40 (FIG. 4C). Additional movement of the user's hand, for example as depicted by vector v2, causes the cursor 45 to move from location 2 to location 1 on the display 40 (FIG. 4D).

The cursor 45 may be moved linearly or accelerated based on vectors v1 and v2. The acceleration may be a constant or non-constant acceleration. According to one embodiment the cursor 45 may be moved at a velocity that is different depending on the direction of the movement relative to the reference point (typically, higher when moving away from the reference point and lower when moving towards the reference point). According to another embodiment the cursor 45 is accelerated at a constant acceleration a1 from location 1 to location 2 and at the same or at a different constant acceleration a2 from location 2 to location 1. According to one embodiment a1>a2. According to another embodiment a1 may be a non-constant acceleration which, for example, increases according to vector v1 (which corresponds to movement of the hand away from the reference point X). a2 may be a non-constant acceleration which decreases according to vector v2 (which corresponds to movement of the hand towards the reference point X).

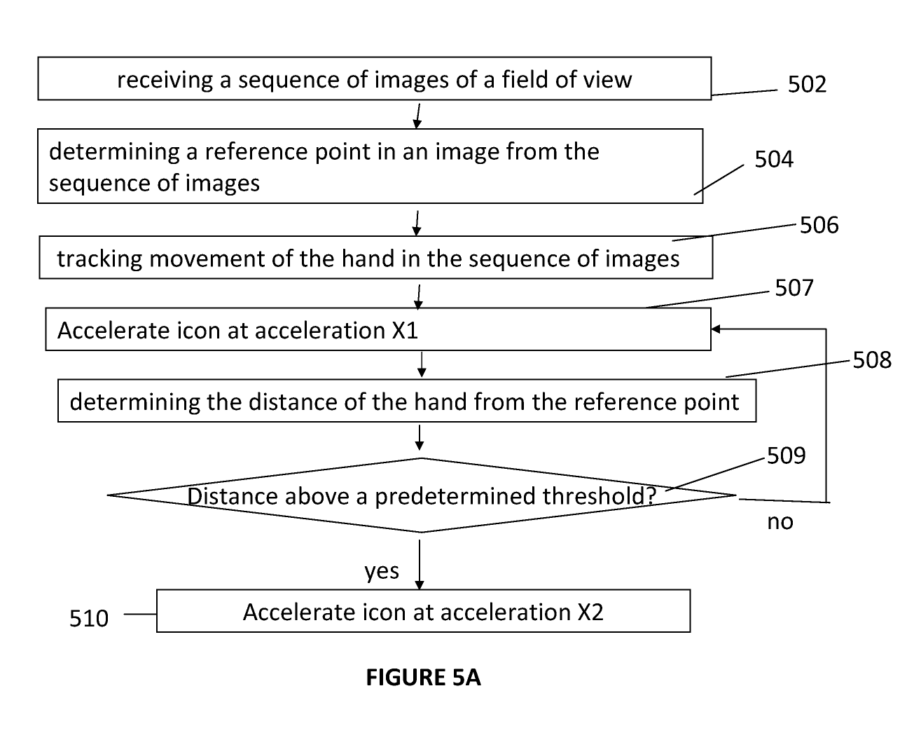

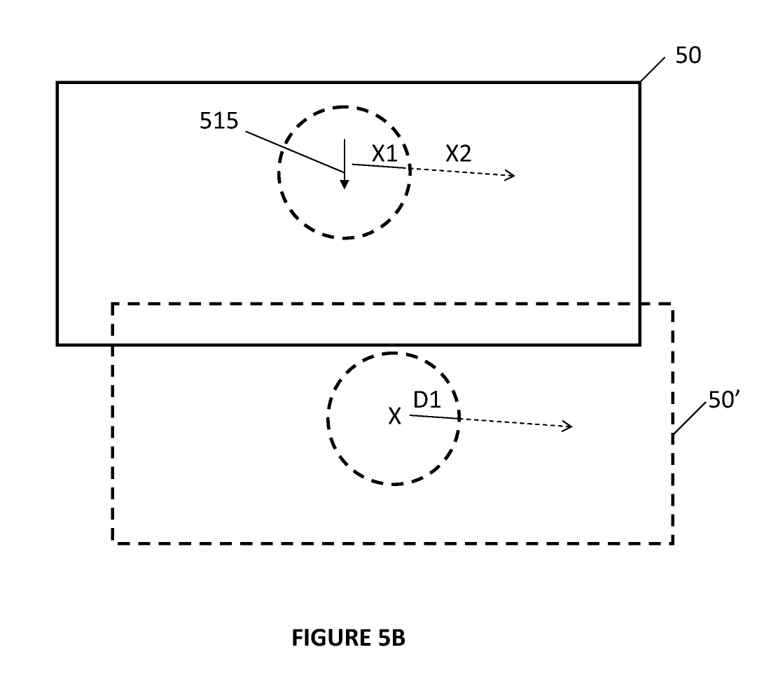

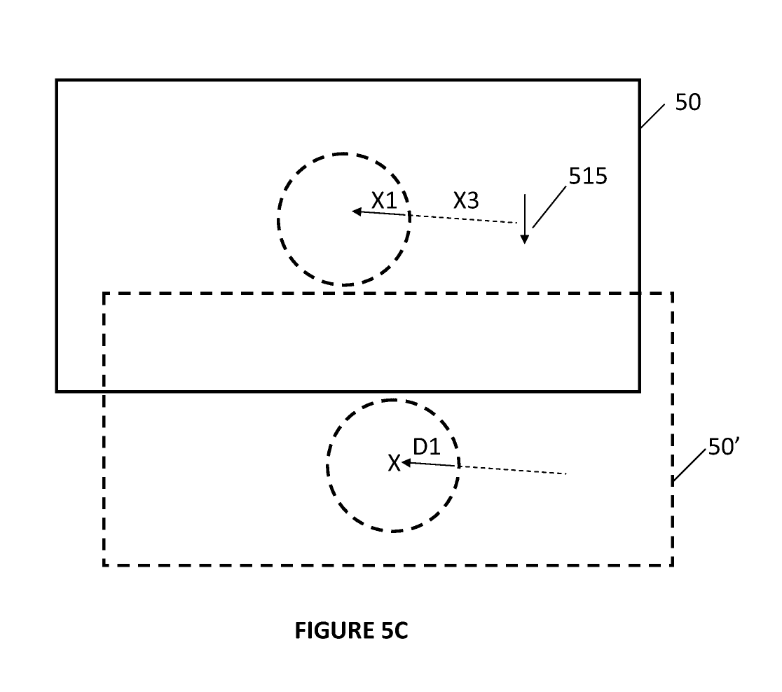

A method for controlling movement of an icon on a display, according to additional embodiments of the invention, is schematically illustrated in FIGS. 5A, 5B and 5C.

The method, which is schematically illustrated in FIG. 5A, includes the steps of receiving a sequence of images of a field of view (502), the images including at least one hand of a user; determining a reference point in an image from the sequence of images (504) and tracking movement of the hand in the sequence of images (506), as described above. The method further includes determining the distance of the hand from the reference point (508) and changing the acceleration of an icon when the distance of the hand from the reference point is above a predetermined distance. Thus, for example, an icon 515 (such as a cursor or any other symbol on a display) may be accelerated on a display 50 at acceleration X1 (507) until it is determined that the distance of the hand from the reference point is above a predetermined distance threshold (509) after which the icon is accelerated at acceleration X2 (510).

Similarly, linear (not accelerated) movement may be changed (enhanced or lowered) according to the distance of the icon from the reference point.

In FIG. 5B acceleration X1 of the icon 515 on the display 50 is maintained while the distance of the hand from the reference point X within the image frame 50′ is up to D1. Acceleration X1 is constant and is not dependant on the direction of movement. Once the distance of the hand from the reference point X within the image frame 50′ is above D1 (e.g. outside of a circle having a radius D1, the center of which is the reference point X) the icon 515 is moved at acceleration X2. Since the direction of movement of icon 515 is away from reference point X, acceleration X2 increases according to the velocity of movement of the user's hand.

In the opposite direction (FIG. 5C) an icon 515 is moved from a location which is above distance D1 from the reference point X, towards reference point X. While the location of icon 515 is at a distance from reference point X that is greater than D1 it will be moved at acceleration X3. Since X3 relates to a movement in a direction towards the reference point X, acceleration X3 will decrease according to the velocity of the user's hand. Once icon 515 is within distance D1 from the reference point X, its acceleration will be constant and independent of direction of movement.

The pre-determined distance threshold may dictate a binary situation or a situation in which the icon acceleration is dependent on the distance of the hand from the reference point. Thus, the acceleration of the icon may be changed in accordance with the distance of the hand from the reference point and in accordance with the direction of the hand's movement relative to the reference point.

According to one embodiment the method includes determining the distance of the hand from the reference point in units that are indicative of the distance of the hand from a camera which obtains the sequence of images, e.g., the distance may be determined in units of width of the user's hand. In this embodiment the method includes determining a width of the user's hand prior to determining the distance of the hand from the reference point. Once an object is determined to be a hand, the width of the hand may be determined based on shape recognition algorithms, for example, as know in the art.

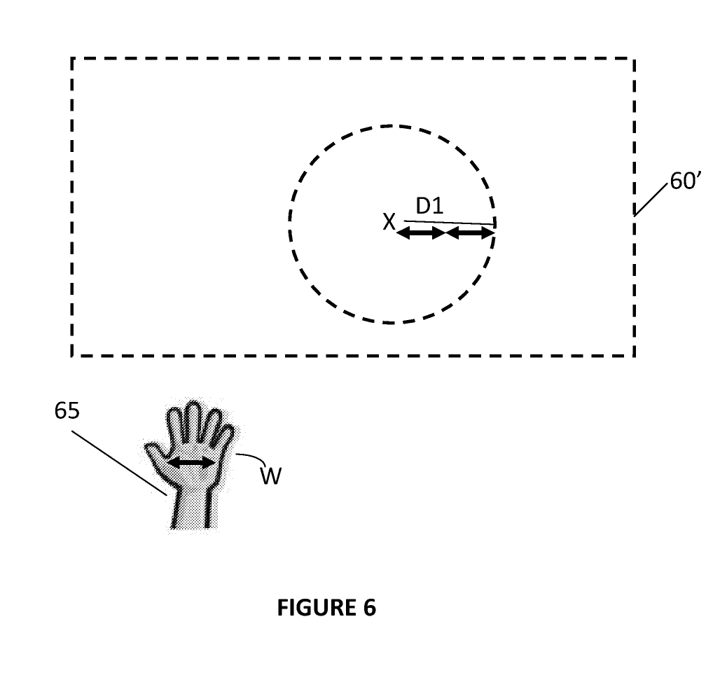

One embodiment for determining the distance of the user's hand from the reference point in units that are indicative of the distance of the hand from a camera is schematically illustrated in FIG. 6.

A width W of a user's hand 65 is determined and a threshold is set to be, for example, two widths of the user's hand. Thus, a circle the center of which is the reference point X and having a radius D1 (which is equal to 2×W and which is the predetermined threshold in this case) is (virtually) created on image frame 60′. According to embodiments of the invention the acceleration of an icon may be changed (as described above) when the distance of the hand is determined to be above the distance D1. Thus, a threshold is determined based, for example, on user characteristics (such as the width of the user's hand) which are indicative of the distance of the user from the camera. This embodiment enables to compensate for the distance of the user from the camera. Other characteristics may be used to determine a pre-determined distance threshold according to embodiments of the invention.

Keeping a user's hand close to a certain reference point helps to keep the user's hand at a set orientation/position in relation to the camera without having the user's hand tire. Using the center of the field of view of the camera as a reference point may be useful especially when the user is close to the camera (e.g., up to 0.5 meter distance from the camera). Using the initial location of the hand of the user as a reference point may be useful in keeping changes in the rotation or pitch of the hand to a minimum.

A method for determining the reference point, in the case where the reference point is the initial position of the hand, according to one embodiment of the invention, includes the steps of making an initial identification of a hand and determining that a location of the hand when the hand is initially identified is the reference point.

Initial identification of a hand may be done by known methods for hand identification. For example, an imaged object may be identified as a hand by using shape detection algorithms. For example, an object may be identified as a hand by detecting movement (typically in a predetermined pattern of movement, such as a wave movement) of the object in a sequence of images and applying a shape recognition algorithm on the moving object to identify a shape of a hand. Other methods include confirming that an object is a hand by combining shape information from at least two images of the object and determining based on the combined information that the object is a hand. Other methods using shape detection may be used. Other methods for identifying a hand which use color detection, contour detection, edge detection and more, are known and may be used. Information from a 3D camera system may also be used to identify a hand.

According to one embodiment determining the reference point, which is the initial position of the hand, includes: making an initial identification of a hand (e.g., as described above); tracking movement of the hand in the sequence of images; determining when movement of the hand is below a predetermined threshold; and determining that a location of the hand when movement of the hand is below the predetermined threshold, is the reference point.

In another embodiment the method includes making an initial identification of a hand (e.g., as described above); identifying a predetermined posture or gesture of the hand (e.g., a wave of the hand or a hand with fingers extended and palm facing the camera); and determining that a location of the hand when the predetermined posture of gesture is identified, is the reference point.

According to some embodiments a reference point which is determined, for example, as described above, may be used in initiation of a device. Movement of a user's hand may be determined to be in a specific direction from the reference point (e.g., up or down, left or right) or may be determined to be performing a specific gesture in relation to the reference point. Initiation of a device may be done based on the movement or gesture of the hand as described above.

In typical settings in which computer vision based control of devices is used, separating a hand from the background, (e.g., from other moving objects in the background or from a colorful background), and thus determining that an object is a hand, may be a challenge.

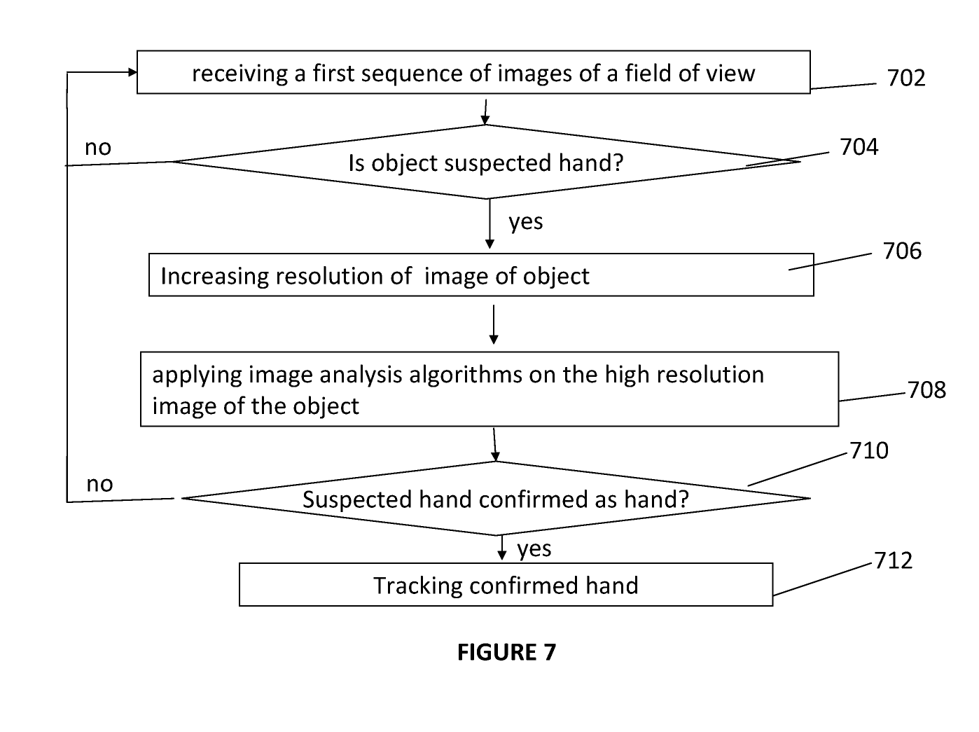

A method for controlling a device, based on computer vision, according to one embodiment of the invention is described in FIG. 7.

According to one embodiment the method includes receiving a first sequence of images of a field of view (702), said images comprising at least one object; determining, based on computer based image analysis of the images, that the object is a suspected hand (704). If the object is not determined to be a suspected hand another sequence of images is checked. If the object is determined to be a suspected hand the resolution of an image from a second sequence of images (typically a sequence of images subsequent to the first sequence of images) is increased (706) to obtain a higher resolution image of the object. It is then confirmed that the object is a hand by applying image analysis algorithms (such as, shape recognition algorithms including, for example, contour detection and edge detection) on the high resolution image of the object (708). If the suspected hand is not confirmed to be a hand (based on the image analysis of the high resolution image) the image resolution may be lowered (e.g., to its original state) and another sequence of images is checked. If the suspected hand is confirmed to be a hand (based on the image analysis of the high resolution image) (710) the confirmed object may be tracked throughout a subsequent sequence of images to control the device (712).

Increasing the resolution of an image may be done by known methods, such as by using optical or digital zoom, using digital image processing to crop an image and enlarge the cropped area, etc.

Controlling a device may include controlling movement of an icon on a display of the device.

According to some embodiments, determining if an object is a suspected hand includes determining movement of an object in a sequence of images. A moving object may be a suspected hand. According to some embodiments, only an object moving in a predefined pattern (such as a repetitive waving motion, a circular motion or an upward or downward movement) may be determined to be a suspected hand.

In some systems, e.g., systems using webcam sensors, the images are of initially high resolution (e.g., HD—1.3M or higher (2M, etc.)). According to one embodiment images may be down scaled to e.g., VGA, to deal with limited USB bandwidth or to avoid excess use of the CPU. Thus, the first sequence of images may include high resolution images that are scaled down by a first factor and increasing resolution of the second sequence of images includes scaling down high resolution images by a second factor, the second factor being smaller than the first factor.

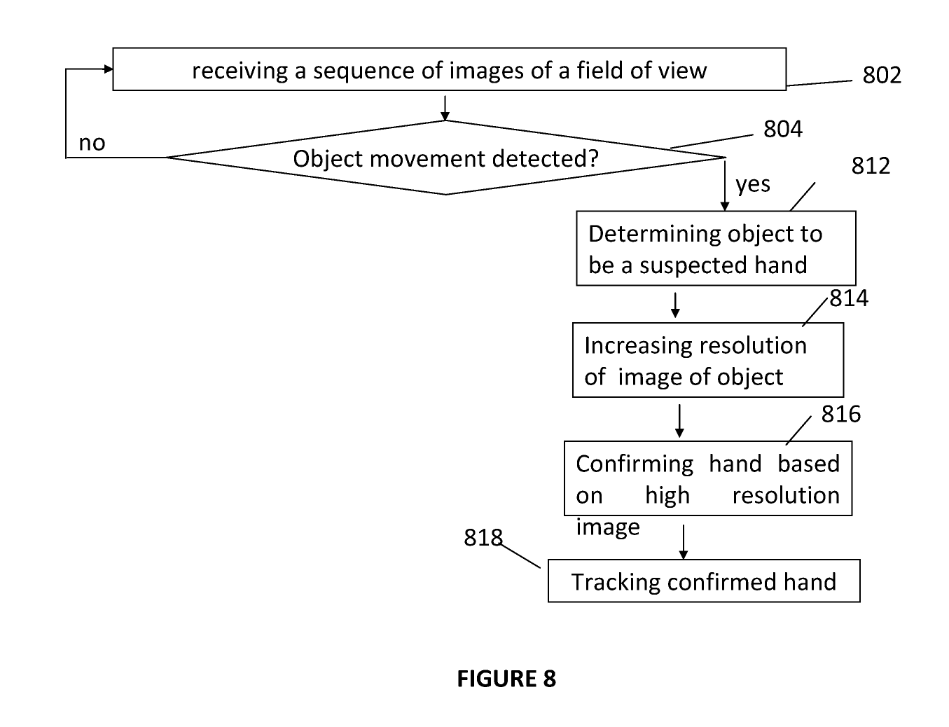

According to one embodiment, which is schematically illustrated in FIG. 8, a method for controlling a device, based on computer vision, includes receiving a sequence of images of a field of view (802), said images comprising at least one object and detecting movement of the object in the images (804). If no movement is detected another sequence of images is checked. If a moving object has been detected the object is determined to be a suspected hand (812). If the object is not determined to be a suspected hand then another sequence of images is checked. If the object is determined to be a suspected hand the resolution of a first image from a second sequence of images is increased (814) to obtain a higher resolution image of the object. It is then confirmed that the object is a hand by applying image analysis algorithms (such as, shape recognition algorithms including contour detection and edge detection) on the high resolution image of the object (816) and the confirmed hand is tracked through the sequence of images to control the device (818).

According to one embodiment of the invention a posture of a hand in combination with other parameters, such as the hand's distance (or change of distance) from the camera, may be used to control content on a display.

According to one embodiment a method for controlling a device, based on computer vision, includes receiving a sequence of images of a field of view from a camera; applying a shape recognition algorithm on the sequence of images to detect a hand in a predetermined posture; detecting a change of distance of the hand in the predetermined posture from the camera; and controlling the device based on the detection of the hand in the predetermined posture and on the detection of the change of distance of the hand from the camera. In this embodiment the detection of a shape of a hand in a predetermined posture enables using the change in distance to control the device.

Controlling the device may include manipulating content displayed on the device.

According to one embodiment a second posture may be detected, the second posture being used to select content and/or to manipulate content. According to one embodiment detecting the hand in the first posture is used to control movement of a cursor on a display of the device and detecting a hand in a second posture is used to manipulate content displayed on the device. Manipulating content may include zooming in or out of the content displayed on the device.

According to one embodiment content is manipulated by zooming in when the change of distance of the hand from the camera is a decrease in the distance of the hand from the camera and zooming out when the change of distance of the hand from the camera is an increase of the distance of the hand from the camera.

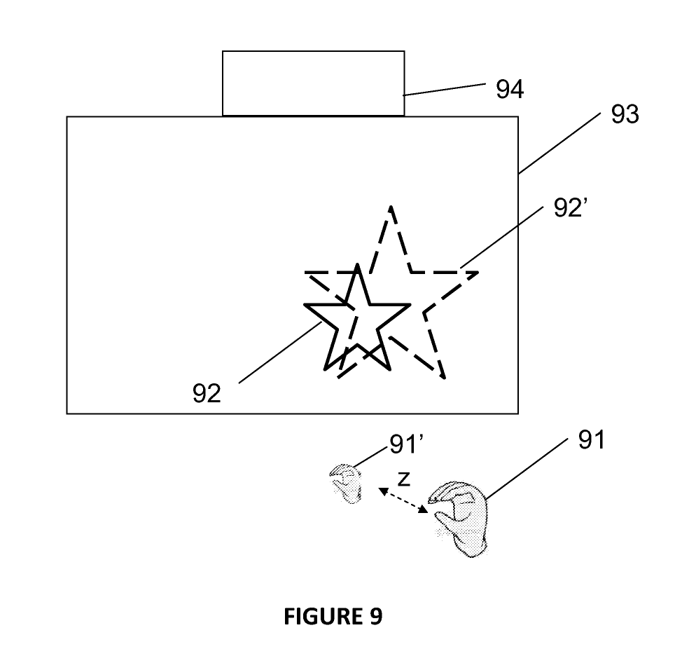

FIG. 9 schematically illustrates a method for controlling displayed content, according to one embodiment of the invention. According to one embodiment a user makes specific hand posture 91, e.g., a posture in which the tips of all fingers of the hand brought together such that the tips touch or almost touch each other, as if the hand is holding a bulb or valve (or another posture, such in which two finger (typically the thumb and another finger) are brought together as if pinching something) to select content 92 on a display 93. The user then moves his hand on the z axis, e.g., to a location 91′ that is closer to the camera 94. Detection of the change in distance of the hand together with detection of the posture 91 causes manipulation of content 92, e.g., zooming in to produce content 92′.

A change in distance of the hand may be determined by tracking the hand (in the specific posture). For example, tracking (in this embodiment and in the embodiments described above) may include selecting clusters of pixels having similar movement and location characteristics in two, typically consecutive images. A shape of a hand in the specific posture may be detected and points (pixels) of interest may be selected from within the detected hand shape area, the selection being based, among other parameters, on variance (points having high variance are usually preferred). Movement of points may be determined by tracking the points from frame n to frame n+1. Known optical flow methods may be used to track the hand.

The size of a hand (in a specific posture) may also be used to detect the distance of a hand from the camera. Typically, an increase in the size of the hand throughout a sequence of images may indicate that the hand is getting closer to the camera and vice versa.

Keeping posture 91 and moving away from camera 94 may cause zooming out of content 92′ back to its original state. Zooming in or out may be performed on selected or non selected content.

1. A method for controlling a device, the method comprising:
receiving a sequence of images of a field of view from a camera;
applying a shape recognition algorithm on the sequence of images to detect a hand in the sequence of images;
identifying a predetermined posture of the hand;
detecting a change of distance from the camera, along a z-axis, of the hand in the predetermined posture; and
controlling the device based on the detection of the hand in the predetermined posture and on the detection of the change of distance of from the camera.

2. The method of claim 1 comprising detecting a predetermined posture of the hand by applying a shape recognition algorithm.

3. The method of claim 1 wherein controlling the device comprises manipulating displayed content.

4. The method of claim 3 wherein detecting the hand in the predetermined posture causes selection of the displayed content and wherein the method comprises manipulating the selected content.

5. The method of claim 1 comprising detecting the hand in a first posture to control movement of a displayed cursor and detecting a hand in a second posture to manipulate displayed content.

6. The method of claim 3 wherein manipulating displayed content comprises zooming in or out of the displayed content.

7. The method of claim 1 wherein detecting a change of distance from the camera comprises determining a size of the hand in the predetermined posture.

8. The method of claim 1 comprising zooming in when the change of distance of the hand from the camera is to decrease the distance of the hand from the camera and zooming out when the change of distance of the hand from the camera is to increase the distance of the hand from the camera.

9. The method of claim 1 comprising detecting a size of the hand in the predetermined posture and zooming in when the size of the hand increases and zooming out when the size of the hand decreases.

10. A method for controlling a device, the method comprising:
applying a shape recognition algorithm on a sequence of images to detect a hand;
identifying a shape of the hand;
detecting a change of distance from an image sensor used to obtain the sequence of images, of the hand in the shape; and
controlling the device based on the detection of the hand in the shape and on the change of distance of from the image sensor.

11. The method of claim 10 wherein controlling the device comprises manipulating displayed content.

12. The method of claim 11 comprising selecting the displayed content based on the identification of the shape of the hand and wherein the method comprises manipulating the selected content.

13. The method of claim 10 comprising detecting the hand in a first shape to control movement of a cursor on a display and detecting a hand in a second shape to manipulate displayed content.

14. The method of claim 13 wherein manipulating content comprises zooming in or out of the displayed content.

15. A system for controlling a device, the system comprising:
an image sensor; and
a processor to receive images from the image sensor, the processor to:
apply a shape recognition algorithm on the sequence of images to detect a hand in the sequence of images;
identify a predetermined posture of the hand;
detect a change of distance from the image sensor, along a z-axis, of the hand in the predetermined posture; and
control the device based on the detection of the hand in the predetermined posture and on the detection of the change of distance of from the image sensor.

16. The system of claim 15 wherein the processor is to detect a predetermined posture of the hand by applying a shape recognition algorithm.

17. The system of claim 15 wherein the processor is to manipulate displayed content.

18. The system of claim 17 wherein identification of the predetermined posture causes selection of the displayed content and wherein the detection a change of distance from the image sensor causes manipulation of the selected content.

19. The system of claim 15 wherein the processor is to detect the hand in a first posture to control movement of a displayed cursor and detect a hand in a second posture to zoom in or out of displayed content.
